(19) United States
(12) Patent Application Publication
(10) Pub. No.: US 2026/0370405 A1
(43) Pub. Date: Nov. 19, 2026

(54) TERMINAL APPARATUS, BASE STATION APPARATUS, AND WIRELESS COMMUNICATION SYSTEM

(71) Applicant: 1FINITY Inc., Kawasaki-shi (JP)

(72) Inventors: TAEWOO LEE, Edogawa (JP); Teppei OYAMA, Kawasaki (JP); Tsuyoshi SHIMOMURA, Yokohama (JP); Shogo UCHIDA, Ota (JP)

(73) Assignee: 1FINITY Inc., Kawasaki-shi (JP)

(21) Appl. No.: 19/753,265

(22) Filed: Jul. 24, 2026

Related U.S. Application Data
(63) Continuation of application No. PCT/JP2024/005422, filed on Feb. 16, 2024.

(51) Int. Cl. H04L 5/00

(52) U.S. Cl. CPC H04L 5/0044; H04L 5/0098

(57) ABSTRACT

A terminal apparatus includes a receiver configured to receive first information regarding a configuration of an uplink (UL) subband and second information regarding a resource of an uplink channel; a controller configured to perform control such that the resource of the uplink channel is located in the UL subband according to the first information and the second information, and a transmitter configured to transmit the uplink channel on the resource.

### CROSS-REFERENCE TO RELATED APPLICATION

This application is a continuation application of International Application PCT/JP2024/005422 filed on Feb. 16, 2024 and designated the U.S., the entire contents of which are incorporated herein by reference.

### FIELD

The present embodiment relates to a terminal apparatus, a base station apparatus, and a wireless communication system.

### BACKGROUND

In current networks, traffic of mobile terminals (smartphones or feature phones) accounts for a majority network resources. In addition, the traffic used by mobile terminals is expected to continue to grow in the future. Furthermore, in addition to the traffic used by mobile terminals, for example, Internet of Things (IoT) services (for example, a monitoring system of a traffic system, a smart meter, an apparatus, or the like) are being deployed. Therefore, networks are needed to cope with services having various requirements. In order to cope with such various services, in communication standards (for example, Non Patent Documents 1 to 14) of the fifth generation mobile communication (5G or New Radio (NR)), for example, in addition to the standard technology of the 4G (fourth generation mobile communication), standards have been formulated assuming support of many use cases classified into enhanced mobile broadband (eMBB), massive machine type communications (MTC), and ultra-reliable and low latency communications (URLLC).

In a working group of the international standardization project called the 3rd generation partnership project (3GPP®), extension technologies of the above communication standards are still being continuously studied and standardized.

For example, the working group of the 3GPP has studied introduction of a subband full duplex (SBFD) technology (Non Patent Document 15). The SBFD technology is a technology for reducing latency and expanding coverage in uplink by configuring an uplink resource on a downlink symbol and/or a flexible symbol.

For example, a related art is disclosed in 3GPP TS 37.324 V17.0.0 (Non Patent Document 1), 3GPP TS 37.340 V17.7.0 (Non Patent Document 2), 3GPP TS 38.201 V17.0.0 (Non Patent Document 3), 3GPP TS 38.202 V17.5.0 (Non Patent Document 4), 3GPP TS 38.211 V17.6.0 (Non Patent Document 5), 3GPP TS 38.212 V17.7.0 (Non Patent Document 6), 3GPP TS 38.213 V17.8.0 (Non Patent Document 7), GPP TS 38.214 V17.8.0 (Non Patent Document 8), 3GPP TS 38.215 V17.4.0 (Non Patent Document 9), 3GPP TS 38.300 V17.7.0 (Non Patent Document 10), 3GPP TS 38.321 V17.7.0 (Non Patent Document 11), 3GPP TS 38.322 V17.3.0 (Non Patent Document 12), 3GPP TS 38.323 V17.5.0 (Non Patent Document 13), 3GPP TS 38.331 V17.7.0 (Non Patent Document 14), and 3GPP TR 38.858 V18.0.0 (Non Patent Document 15).

### SUMMARY

According to an aspect of the embodiments, a terminal apparatus including a receiver configured to receive first information regarding a configuration of an uplink (UL) subband and second information regarding a resource of an uplink channel, a controller configured to perform control such that the resource of the uplink channel is located in the UL subband according to the first information and the second information, and a transmitter configured to transmit the uplink channel on the resource.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a wireless communication system according to an embodiment;

FIG. 2 is a diagram illustrating an example of a functional configuration diagram of a base station apparatus according to the present embodiment;

FIG. 3 is a diagram illustrating an example of a functional configuration diagram of a terminal apparatus according to the present embodiment;

FIG. 4 is a diagram illustrating an example of a slot configuration according to the present embodiment;

FIG. 5 is a diagram illustrating an example of a relationship among a value μ, a slot, a frame, and a subframe according to the present embodiment;

FIG. 6 is a diagram illustrating an example of a method of configuring a UL subband according to the present embodiment;

FIG. 7 is a diagram illustrating an example of a physical uplink control channel (PUCCH) resource set table in a case where the terminal apparatus does not have a dedicated PUCCH resource configuration in the present embodiment;

FIG. 8 illustrates an example of a resource grid in which the UL subband is configured in the present embodiment;

FIG. 9 is a sequence diagram of the wireless communication system according to the present embodiment;

FIG. 10 is a diagram illustrating an example of a hardware configuration of the base station apparatus according to the present embodiment; and

FIG. 11 is a diagram illustrating an example of a hardware configuration of the terminal apparatus according to the present embodiment.

### DESCRIPTION OF EMBODIMENTS

The SBFD configures an uplink resource on a downlink symbol, for example. The uplink resource may be an uplink subband (UL subband). With the introduction of the SBFD, a problem may occur in which an uplink channel and/or an uplink signal is not located in the uplink subband. Since a position of the uplink channel and/or the uplink signal is derived based on the number of resource blocks (RBs) of an uplink bandwidth part (BWP), such a problem may occur when the number of RBs of the uplink subband and the number of RBs of the uplink BWP are different from each other.

Hereinafter, the present embodiment will be described in detail with reference to the drawings. Problems and embodiments in the present specification are merely examples, and do not limit the scope of rights of the present application. In particular, the technology of the present application can be applied to even different expressions as long as the expressions are technically equivalent even if the expressions are different, and the scope of rights is not limited. Each embodiment can be appropriately combined within a range in which processing contents do not contradict each other.

In addition, terms and technical contents described in the present specification may be appropriately used as terms and technical contents described in a specification or a contribution as a communication standard such as the 3rd generation partnership project (3GPP). Such specifications are described in Non Patent Documents 1 to 15, for example.

Hereinafter, embodiments of a base station, a terminal, and a wireless communication system disclosed in the present application will be described in detail with reference to the drawings. Note that the following embodiments do not limit the disclosed technology.

### First Embodiment

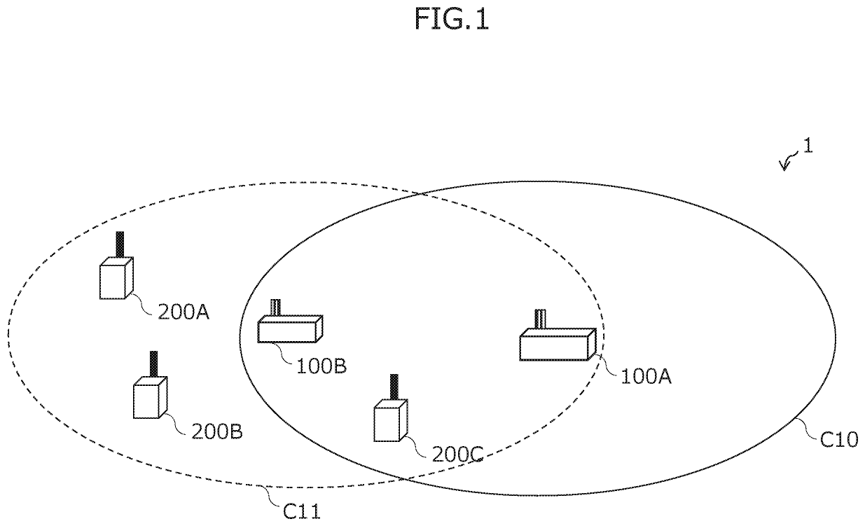

FIG. 1 is a diagram illustrating an example of a wireless communication system according to a first embodiment. A wireless communication system 1 may include a base station apparatus 100A, a base station apparatus 100B, a terminal apparatus 200A, a terminal apparatus 200B, and a terminal apparatus 200C. Note that, in a case where the terminal apparatus 200A, the terminal apparatus 200B, and the terminal apparatus 200C are not distinguished from one another, they are simply referred to as the terminal apparatus 200. Note that the base station apparatus 100A forms a cell C10. Note that the cell C10 may be referred to as a coverage of the base station apparatus 100A. Further, the base station apparatus 100B forms a cell C11. Note that the cell C11 may be referred to as a coverage of the base station apparatus 100B. In a case where the base station apparatus 100A and the base station apparatus 100B are not distinguished from each other, they are simply referred to as the base station apparatus 100. Note that the terminal apparatus 200 is located within the coverage of any of the base station apparatuses 100.

Note that the base station apparatus 100 may be, for example, a macro wireless base station, a small wireless base station such as a pico wireless base station (including a micro wireless base station, a femto wireless base station, and the like), and other wireless base stations of various scales, and may be paraphrased as a wireless communication apparatus, a communication apparatus, a transmission apparatus, or the like. Furthermore, the terminal apparatus 200 may be, for example, a wireless terminal such as various apparatuses and devices (sensor apparatuses and the like) having a wireless communication function, such as a mobile phone, a smartphone, a personal digital assistant (PDA), a personal computer, and a vehicle, and may be paraphrased as a wireless communication apparatus, a communication apparatus, a reception apparatus, a mobile station, or the like.

The base station apparatus 100 is connected to a network via a wired connection with a network apparatus (an upper-level apparatus or another base station) (not illustrated). Note that the base station apparatus 100 may be connected to the network apparatus in a wireless manner instead of a wired manner.

The base station apparatus 100 may be separated into different devices having a wireless communication function with the terminal apparatus 200 and a digital signal processing and control function, respectively. In this case, the apparatus having the wireless communication function can be referred to as a remote radio head (RRH), and the apparatus having the digital signal processing and control function can be referred to as a base band unit (BBU). In addition, the RRHs may be installed to be remotely deployed from the BBU, and the RRHs and the BBU may be connected to each other in a wired manner with an optical fiber or the like. Alternatively, the RRHs and the BBU may be connected in a wireless manner. Further, for example, the base station apparatus 100 may be separated into a central unit (CU), a distributed unit (DU), and a radio unit (RU) instead of the RRHs and the BBU described above. The DU has, for example, a function of a media access control (MAC) layer. In addition, the DU may have, for example, a function of a radio link control (RLC) layer. The RU includes at least a radio frequency (RF) wireless circuit. The DU and the RU may be integrated with each other.

Meanwhile, the terminal apparatus 200 communicates with the base station apparatus 100 by wireless communication.

Note that, in a case where a radio resource control (RRC) connection is not established between the base station apparatus 100 and the terminal apparatus 200, the base station apparatus 100 performs processing for establishing the RRC connection. Note that processing for establishing the RRC connection may include a random access procedure.

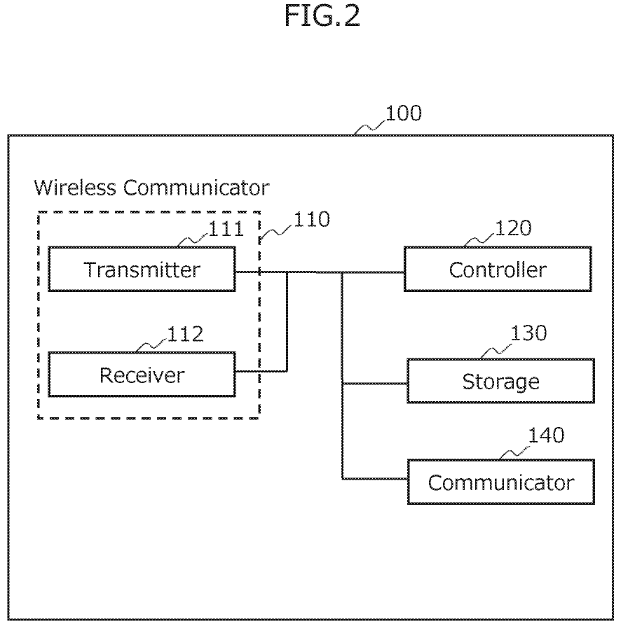

Next, the base station apparatus 100 will be described. FIG. 2 is a diagram illustrating an example of a functional configuration diagram of the base station apparatus 100 according to the present embodiment. The base station apparatus 100 includes a wireless communicator 110, a controller 120, a storage 130, and a communicator 140.

The wireless communicator 110 includes a transmitter 111 and a receiver 112, and performs wireless communication with the terminal apparatus 200. Specifically, the transmitter 111 transmits, to the terminal apparatus 200, downlink signals such as a random access procedure signal, a downlink physical signal, an RRC layer signal, a downlink data signal, and a downlink control signal.

Furthermore, the receiver 112 can receive, for example, uplink signals such as a random access procedure signal, an RRC layer signal, an uplink data signal, and an uplink control signal, which are transmitted from the terminal apparatus 200.

The controller 120 controls the base station apparatus 100. Specifically, the controller 120 can control establishment of the RRC connection with the terminal apparatus 200, signal processing of a signal received by the receiver 112, generation of a transport block (TB), mapping of the transport block to a wireless resource, and the like. In addition, the controller 120 calculates transmission power of a downlink channel and/or an uplink channel and determines a radio network temporary identifier (RNTI).

The storage 130 can store, for example, a downlink data signal.

The communicator 140 is connected to the network apparatus (for example, an upper-level apparatus or another base station) in a wired or wireless manner to perform communication. A data signal directed to the terminal apparatus 200, which is received by the communicator 140, can be stored in the storage 130.

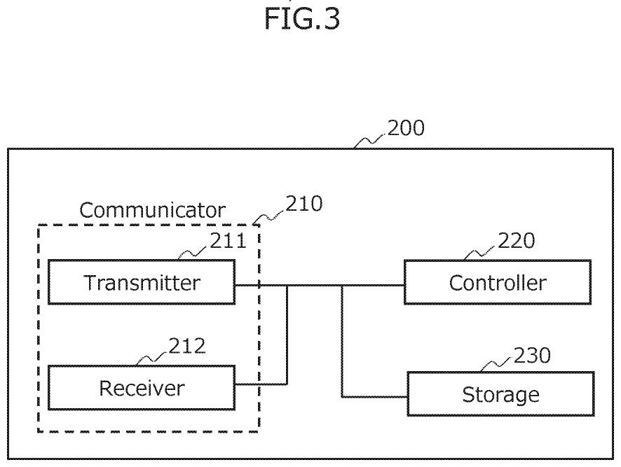

Next, the terminal apparatus 200 will be described. FIG. 3 is a diagram illustrating an example of a functional configuration diagram of the terminal apparatus 200 according to the present embodiment. As illustrated in FIG. 3, the terminal apparatus 200 includes a communicator 210, a controller 220, and a storage 230. Such components are connected such that signals and data can be input and output in one direction or in both directions. Note that the communicator 210 can be described separately as a transmitter 211 and a receiver 212.

The transmitter 211 transmits a data signal and a control signal by wireless communication via an antenna. Note that the antenna may be common for transmission and reception. The transmitter 211 transmits, for example, uplink signals such as a random access procedure signal, an RRC layer signal, an uplink data signal, and an uplink control signal.

The receiver 212 receives, for example, downlink signals such as a random access procedure signal, a downlink data signal, and a downlink control signal, which are transmitted from the base station apparatus 100. Furthermore, the signal to be received may include, for example, a reference signal used for channel estimation and demodulation.

The controller 220 controls the terminal apparatus 200. Specifically, the controller 220 can control establishment of the RRC connection with the base station apparatus 200, signal processing of a signal received by the receiver 212, generation of a transport block (TB), mapping of the transport block to a wireless resource, and the like. In addition, the controller 220 can calculate transmission power of an uplink signal and/or an uplink channel and determine an RNTI.

The storage 230 can store, for example, an uplink data signal. In addition, the storage 230 can store configuration information (setting information) related to wireless communication, the configuration information being transmitted from the base station apparatus 100.

Note that the wireless communicator 110 of the base station apparatus 100 and the communicator 210 of the terminal apparatus 200 may include an antenna port.

Uplink may be referred to as UL. Downlink may be referred to as DL.

An uplink channel may include some or all of a physical uplink shared channel (PUSCH), a physical uplink control channel (PUCCH), a physical random access channel (PRACH), and a sounding reference signal (SRS).

An uplink signal may be a signal transmitted via a PUSCH, a PUCCH, a PRACH, and an SRS.

A downlink channel may include some or all of a physical downlink shared channel (PDSCH), a physical downlink control channel (PDCCH), a physical broadcast channel (PBCH), a synchronization signal block (SSB), and a channel state information reference signal (CSI-RS).

A downlink signal may be a signal transmitted via a PDSCH, a PDCCH, and a PBCH. The downlink signal may include a downlink reference signal.

A higher layer parameter may be any one or all of an RRC parameter, a media access control control element (MAC CE), a system information block (SIB), and a master information block (MIB).

Here, an example of a slot for the base station apparatus 100 and the terminal apparatus 200 to perform wireless communication will be described.

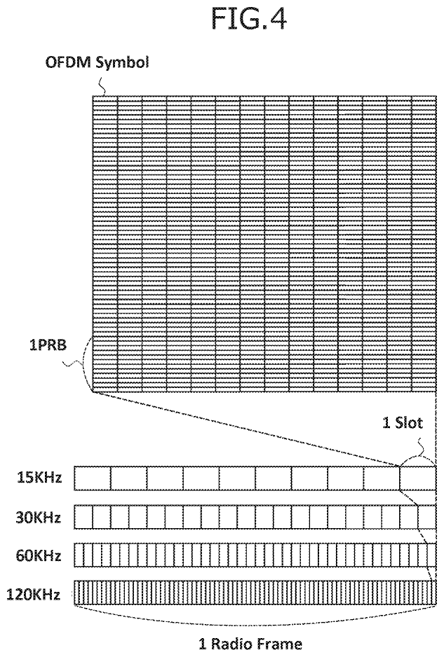

FIG. 4 is a diagram illustrating an example of a slot configuration according to the present embodiment. A radio frame described in FIG. 4 may be 10 milliseconds (msec). Note that the radio frame may be referred to as a frame. Further, the radio frame may be referred to as a system frame. Furthermore, the radio frame includes, for example, 10 subframes.

In the radio frame described in FIG. 4, for example, a time-domain length of the radio frame is determined according to a subcarrier spacing (SCS). For example, the subcarrier spacing is determined based on a relationship of SCS=15×2 μ(kHz). That is, μ=0 means that the subcarrier spacing is 15 kHz. Hereinafter, μ may be described as a value μ or a value μ for determining the subcarrier spacing.

For the subcarrier spacing of 15 kHz, one frame may include 10 slots. One slot includes, for example, 14 orthogonal frequency division multiplexing (OFDM) symbols. The OFDM symbol includes, for example, a plurality of physical resource blocks (PRBs). One physical resource block may include, for example, 12 subcarriers.

Note that a slot is numbered as nsμby using, for example, the subcarrier spacing μ. For example, nsμ is numbered in an increasing order, for example, in a range of {0, 1, 2, ··· , Nslotsubframe, μ−1} in one subframe. nsμ is numbered in an increasing order, for example, in a range of {0, 1, 2, ···, Nslotframe, μ−1} in one frame. One slot may include Nsymbslot OFDM symbols. A value of Nsymbslot may vary depending on a length of a cyclic prefix (CP).

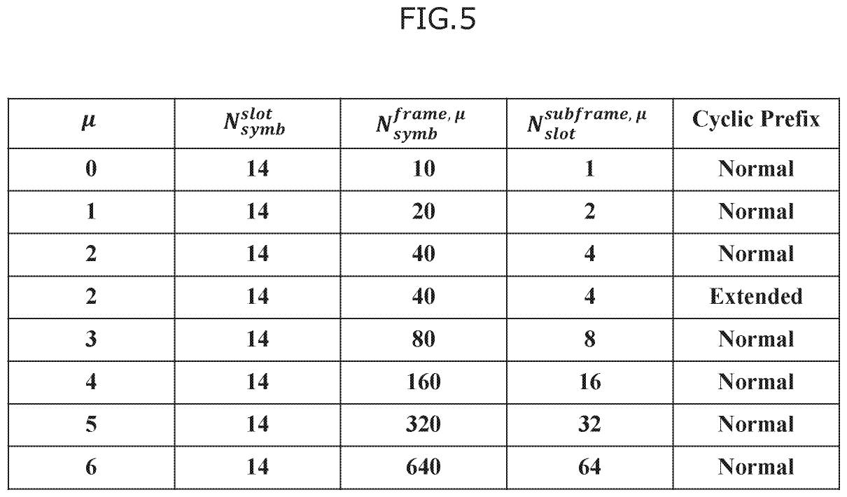

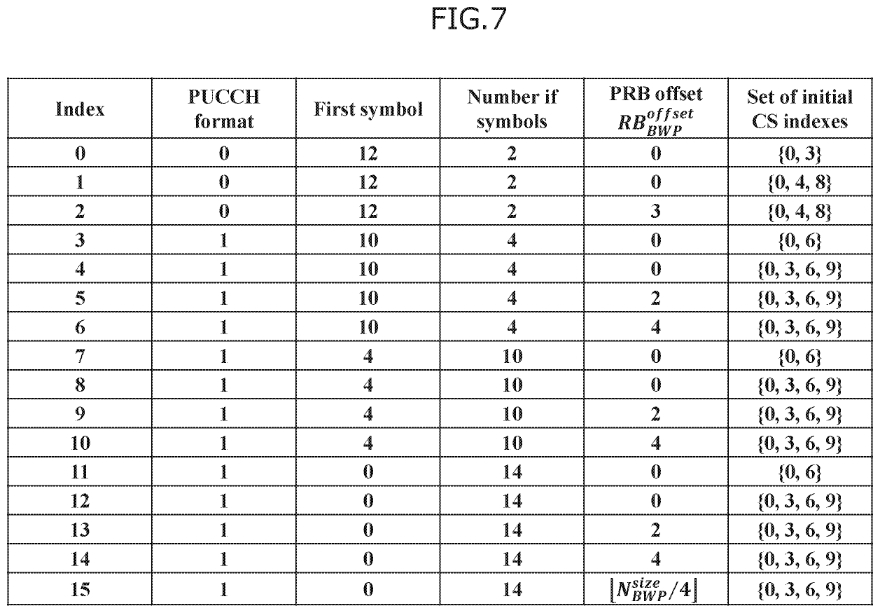

FIG. 5 is a diagram illustrating an example of a relationship among the value μ, a slot, a frame, and a subframe according to the present embodiment. Note that a Normal CP may be adopted for all values μ. Further, when μ=2, an Extended CP may be adopted. In a time domain, a length of the Normal CP may be shorter than that of the Extended CP. In addition, FIG. 7 illustrates an example of Nslotframe, μ, which is the number of slots included in one radio frame for the value μ, and the number of slots included in one subframe for the value μ.In the case of the Normal CP, for example, one slot includes 14 OFDM symbols. In the case of the Extended CP, for example, one slot includes 12 OFDM symbols. In the first embodiment, it is assumed that the Normal CP is applied unless otherwise specified. Note that the technology in the first embodiment can be applied to the Normal CP and the Extended CP.

The subcarrier spacing may be referred to as numerology. Different numerologies may mean different subcarrier spacings.

A time resource may be one or more OFDM symbols. The time resource may be one or more slots. The time resource may be one or more system frames.

A frequency resource may be one or more subcarriers. The frequency resource may be one or more PRBs.

The antenna port may be defined such that a channel over which a symbol is transmitted on a certain antenna port can be inferred from a channel over which a different symbol is transmitted on the same antenna port. That is, a plurality of symbols transmitted on the same antenna port and at different time instances can be considered to be transmitted over the same channel.

In a case where a large scale property of a channel over which a symbol is transmitted on one antenna port can be inferred from a channel over which a different symbol is transmitted on the other antenna port, it may be said that the two antenna ports are quasi co-located (QCL). The large scale property may include some or all of one or more delay spreads, Doppler spreads, Doppler shifts, average gains, average delays, and spatial reception parameters.

In each numerology and carrier, a resource grid may be defined by Ngrid,xsize,μ×NscRB subcarriers and Nsymbsubframe, μ OFDM symbols. NscRB may be 12.

In Frequency Range 1 (FR1), a carrier frequency may be 6 GHz or less. In FR2, a carrier frequency may be 6 GHz or more.

Time division duplex (TDD) may be referred to as unpaired spectrum.

A random access preamble sequence supports four or more different lengths. The four or more different lengths may include at least 139, 571, 839, and 1151.

A random access preamble sequence whose length is 839 may be applied to SCSs of 1.25 kHz and/or 5 kHz. A random access preamble sequence whose length is 139 may be applied to SCSs of 15 kHz, 30 kHz, 60 kHz, 120 kHz, 480 kHz, and 960 kHz. A random access preamble sequence whose length is 571 may be applied to SCSs of 30 kHz and/or 120 kHz and/or 480 kHz. A random access preamble sequence whose length is 1151 may be applied to SCSs of 15 kHz and/or 120 kHz.

A plurality of PRACH preamble formats may be defined by one or more PRACH OFDM symbols, different cyclic prefixes (CPs), and guard times. A PRACH preamble configuration may be provided to the terminal apparatus 200 through system information.

A physical uplink control channel (PUCCH) may carry uplink control information (UCI) from the terminal apparatus 200 to the base station apparatus 100. The PUCCH may have five formats depending on the number of PUCCH symbols (duration) and a UCI payload size.

A PUCCH format 0 (PUCCH Format 0) may be a short PUCCH including one or two symbols. The PUCCH format 0 may have a capacity to multiplex up to six terminal apparatuses 200 having a 1-bit payload in the same PRB. The UCI transmitted in the PUCCH format 0 may be 2 bits or less.

A PUCCH format 1 (PUCCH Format1) may be a long PUCCH including four or more symbols and 14 or less symbols. The PUCCH format 1 may have a capacity to multiplex up to 84 terminal apparatuses 200 in the case of no frequency hopping in the same PRB. The PUCCH format 1 may have a capacity to multiplex up to 36 terminal apparatuses 200 in the case of frequency hopping in the same PRB. The UCI transmitted in the PUCCH format 1 may be 2 bits or less.

A PUCCH format 2 (PUCCH Format2) may be a short PUCCH including one or two symbols. In the PUCCH format 2, multiplexing among the terminal apparatuses 200 does not have to be performed in the same PRB. The UCI transmitted in the PUCCH format 2 may be more than 2 bits (or 3 or more bits).

A PUCCH format 3 (PUCCH Format3) may be a long PUCCH including four or more symbols and 14 or less symbols. In the PUCCH format 3, multiplexing among the terminal apparatuses 200 does not have to be performed in the same PRB. The UCI transmitted in the PUCCH format 3 may be more than 2 bits (or 3 or more bits).

A PUCCH format 4 (PUCCH Format4) may be a long PUCCH including four or more symbols and 14 or less symbols. The PUCCH format 4 may have a capacity to multiplex up to four terminal apparatuses 200 in the same PRB. The UCI transmitted in the PUCCH format 4 may be more than 2 bits (or 3 or more bits).

A short PUCCH format of up to 2 UCI bits may be based on sequence selection. In a short PUCCH format of more than 2 UCI bits, the UCI and a demodulation reference signal (DMRS) may be frequency-multiplexed. In a long PUCCH format, the UCI and the DMRS may be time-multiplexed. The frequency hopping may be supported in a long PUCCH format and a short PUCCH format with a length of two symbols. In a long PUCCH format, repeated transmission may be performed over a plurality of slots.

In the TDD, the base station apparatus 100 may determine a slot format. In the TDD, the base station apparatus 100 may transmit slot format configuration information to the terminal apparatus 200. The terminal apparatus 200 may determine the slot format based on the slot format configuration information. The base station apparatus 100 may know the slot format of the terminal apparatus 200 in a cell included in the base station apparatus 100. The slot format configuration information may be one or more higher layer parameters, or may be one or more physical layer signals.

In a case where slot format configuration information tdd-UL-DL-ConfigurationCommon is provided to the terminal apparatus 200, the terminal apparatus 200 sets the slot format for each of a plurality of slots according to an indication of the slot format configuration information. Setting the slot format may be determining the slot format. The slot format configuration information tdd-UL-DL-ConfigurationCommon may be a higher layer parameter.

The slot format configuration information tdd-UL-DL-ConfigurationCommon provides μref (reference SCS configuration), which is a reference SCS, and pattern1. μref may be an integer of 0 or more. pattern1 may provide a parameter dl-UL-TransmissionPeriodicity for configuring a slot configuration period of P milliseconds (msec), a parameter nrofDownlinkSlots for configuring the number dslots of downlink slots, a parameter nrofDownlinkSymbols for configuring the number dsym of downlink symbols, a parameter nrofUplinkSlots for configuring the number uslots of uplink slots, and a parameter nrofUplinkSymbols for configuring the number usym of uplink symbols. A millisecond is equal to 1/1000 of a second.

The slot configuration period of P milliseconds includes S=P×2 μref slots when the SCS is μref. For example, in a case where P is 2.5 and μref is 1, five slots (that is, S=5) may be included in an interval of 2.5 milliseconds. In the S slots, the first dslots slots may be only downlink slots. Further, the last uslots slots may be only uplink slots. Here, the first dslots slots may be earlier slots in time series in the S slots. The last uslots slots may be later slots in time series. That is, the first dslots slots may be earlier slots in time series than the last uslots slots. dsym symbols after the first dslots slots may be downlink symbols. usym symbols before the last uslots slots may be uplink symbols. In the S slots, fsym symbols may be flexible symbols. Here, fsym=(S−dslots−uslots)×NSymbslot−dsym−usym may be satisfied. That is, dslots, dsym, fsym, usym, and uslots may be arranged in this order in time series in the S slots.

A downlink symbol may be included in a downlink slot. An uplink symbol may be included in an uplink slot. The first symbol of every 20/P period may be the first symbol of an even frame.

In a case where the slot format configuration information tdd-UL-DL-ConfigurationCommon provides pattern1 and pattern2, the terminal apparatus 200 may set the slot format for each slot on the first number of slots indicated by pattern1 and set the slot format for each slot on the second number of slots indicated by pattern2.

pattern2 may provide a parameter dl-UL-TransmissionPeriodicity for configuring a slot configuration period of P2 milliseconds (msec), a parameter nrofDownlinkSlots for configuring the number dslots,2 of downlink slots, a parameter nrofDownlinkSymbols for configuring the number dsym,2 of downlink symbols, a parameter nrofUplinkSlots for configuring the number uslots,2 of uplink slots, and a parameter nrofUplinkSymbols for configuring the number usym,2 of uplink symbols.

A slot configuration period of P+P2 milliseconds may include the first S=P×2 μref slots followed by S2=P2×2 μref slots in time series in a case where the SCS is μref. In the S2 slots, the first dslots,2 slots may be only downlink slots. Further, the last uslots,2 slots may be only uplink slots. Here, the first dslots, 2 slots may be earlier slots in time series in the S slots. The last uslots,2 slots may be later slots in time series. That is, the first dslots,2 slots may be earlier slots in time series than the last uslots,2 slots. dsym,2 symbols after the first dslots,2 slots may be downlink symbols. usym,2 symbols before the last uslots,2 slots may be uplink symbols. In the S2 slots, fsym,2 symbols may be flexible symbols. Here, fsym,2=(S2−dslots,2−uslots,2)×NSymbslot−dsym,2−usym,2 may be satisfied. That is, dslots,2, dsym,2, fsym,2, usym,2, and uslots,2 may be arranged in this order in time series in the S2 slots.

In a downlink slot and/or a downlink symbol, the terminal apparatus 200 may receive a downlink channel and/or a downlink signal. For example, the terminal apparatus 200 may receive a PDSCH, a PDCCH, a PBCH, a CSI-RS, or an SSB in a downlink slot and/or a downlink symbol. In an uplink slot and/or an uplink symbol, the terminal apparatus 200 may receive an uplink channel and/or an uplink signal. For example, the terminal apparatus 200 may transmit a PUSCH, a PUCCH, a PRACH, or an SRS in an uplink slot and/or an uplink symbol. In a flexible slot and/or a flexible symbol, the terminal apparatus 200 may receive a downlink channel or a downlink signal scheduled by a downlink control information (DCI) format. In a flexible slot and/or a flexible symbol, the terminal apparatus 200 may transmit an uplink channel or an uplink signal scheduled by a DCI format. In a flexible slot and/or a flexible symbol, the terminal apparatus 200 may transmit a PRACH.

In a set of symbols of a slot that is indicated to be flexible by tdd-UL-DL-ConfigurationCommon and/or tdd-UL-DL-ConfigurationDedicated, in a case where the terminal apparatus 200 is not configured to monitor a PDCCH for DCI format 2_0, or in a case where tdd-UL-DL-ConfigurationCommon and tdd-UL-DL-ConfigurationDedicated are not provided to the terminal apparatus 200, when the terminal apparatus 200 receives a corresponding indication by the DCI format, the terminal apparatus 200 may receive a PDSCH or a CSI-RS in the set of the symbols of the slot.

In a set of symbols of a slot that is indicated to be flexible by tdd-UL-DL-ConfigurationCommon and/or tdd-UL-DL-ConfigurationDedicated, in a case where the terminal apparatus 200 is not configured to monitor a PDCCH for DCI format 2_0, or in a case where tdd-UL-DL-ConfigurationCommon and tdd-UL-DL-ConfigurationDedicated are not provided to the terminal apparatus 200, when the terminal apparatus 200 receives a corresponding indication by the DCI format or a random access response (RAR) UL grant, a fallbackRAR UL grant, or a successRAR, the terminal apparatus 200 may transmit a PUSCH, a PUCCH, a PRACH, or an SRS in the set of the symbols of the slot.

In the terminal apparatus 200 configured to operate in a bandwidth part (BWP) of a serving cell, a set of up to four BWPs may be configured by a higher layer of the serving cell. The set of BWPs may include an uplink BWP (UL BWP) and a downlink BWP (DL BWP). The DL BWP may be used for reception by the terminal apparatus 200 in a downlink bandwidth. The DL BWP may be configured based on a higher layer parameter BWP-Downlink, or may be configured based on a higher layer parameter initialDownlinkBWP using a set of parameters including a higher layer parameter BWP-DownlinkCommon and a higher layer parameter BWP-DownlinkDedicated. The UL BWP may be used for transmission by the terminal apparatus 200 in an uplink bandwidth. The UL BWP may be configured based on a higher layer parameter BWP-Uplink, or may be configured based on a higher layer parameter initialUplinkBWP using a set of parameters including a higher layer parameter BWP-UplinkCommon and a higher layer parameter BWP-UplinkDedicated.

In a case where the higher layer parameter initialDownlinkBWP is not provided to the terminal apparatus 200, an initial DL BWP may be configured by a position and a quantity of consecutive PRBs starting from a PRB with the lowest index and ending with a PRB with the highest index among PRBs of a CORESET for a Type0-PDCCH CSS set. In a case where the higher layer parameter initialDownlinkBWP is not provided to the terminal apparatus 200, a bandwidth of the initial DL BWP may be the same as a bandwidth of the CORESET in which the Type0-PDCCH CSS set is configured. In a case where the higher layer parameter initialDownlinkBWP is not provided to the terminal apparatus 200, an SCS of the initial DL BWP and a cyclic prefix for PDCCH reception may be the same as an SCS and a cyclic prefix of the CORESET in which the Type0-PDCCH CSS set is configured. In a case where the higher layer parameter initialDownlinkBWP is provided to the terminal apparatus 200, the initial DL BWP may be provided by the higher layer parameter initialDownlinkBWP. In the case of operation in a primary cell or a secondary cell, an initial UL BWP may be provided to the terminal apparatus 200 by InitialUplinkBWP. In a case where a supplementary UL carrier is configured in the terminal apparatus 200, the initial UL BWP may be provided to the terminal apparatus 200 on the supplementary UL carrier by InitialUplinkBWP.

The terminal apparatus 200 may transmit an uplink channel and/or an uplink signal in the UL BWP. The terminal apparatus 200 may receive a downlink channel and/or a downlink signal in the DL BWP.

In subband full duplex (SBFD), transmission and reception may be simultaneously performed at the same time instance in the base station apparatus. For example, the base station apparatus 100 supporting the SBFD can simultaneously perform PDSCH transmission and PUSCH reception in the same slot. In a case where the SBFD is configured for a certain terminal apparatus 200, the terminal apparatus 200 does not have to simultaneously perform uplink transmission and downlink reception. For example, the terminal apparatus 200 for which the SBFD is configured does not simultaneously perform PUSCH transmission and PDSCH reception at the same time instance.

In a case where the SBFD is configured for the terminal apparatus 200, the SBFD may be configured for one or more component carriers (CCs).

The SBFD may be refer to allocation of part or all of frequency resources configurable on a downlink symbol to uplink. The SBFD may be refer to allocation of part or all of frequency resources configurable on a flexible symbol to an uplink. A frequency resource allocated to an uplink as part or all of the frequency resources configurable on the downlink symbol or the flexible symbol may be referred to as a UL subband. The UL subband may be an uplink subband. The terminal apparatus 200 may transmit an uplink channel or an uplink signal in the UL subband. For example, the terminal apparatus 200 may transmit a PUCCH in the UL subband. For example, the terminal apparatus 200 may transmit a PUSCH in the UL subband. For example, the terminal apparatus 200 may transmit a PRACH in the UL subband. For example, the terminal apparatus 200 may transmit an SRS in the UL subband.

An SBFD symbol may be a symbol on which the UL subband is configured. The SBFD symbol may be a slot including a symbol on which the UL subband is configured.

The base station apparatus 100 may provide, to the terminal apparatus 200, configuration information of the UL subband. The configuration information of the UL subband may include some or all of a starting PRB index of the UL subband, a bandwidth of the UL subband, a symbol index where the UL subband is configured, and a slot index in which the UL subband is configured.

A period of the configuration of the SBFD symbol in the time domain may be the same as the period P included in the slot format configuration information. In a case where pattern2 is provided to the terminal apparatus 200, the period of the configuration of the SBFD symbol in the time domain may be the same as the sum of the period P and the period P2 included in the slot format configuration information. Within the period of the configuration of the SBFD symbol in the time domain, the base station apparatus 100 may provide, to the terminal apparatus 200, information regarding a time resource where the SBFD symbol is configured by using a higher layer parameter SBFDTimeResourceIndication. The base station apparatus 100 may provide, to the terminal apparatus 200, the information regarding the time resource where the SBFD symbol is configured by using DCI. The terminal apparatus 200 may configure the SBFD symbol based on the information regarding the time resource where the SBFD symbol is configured.

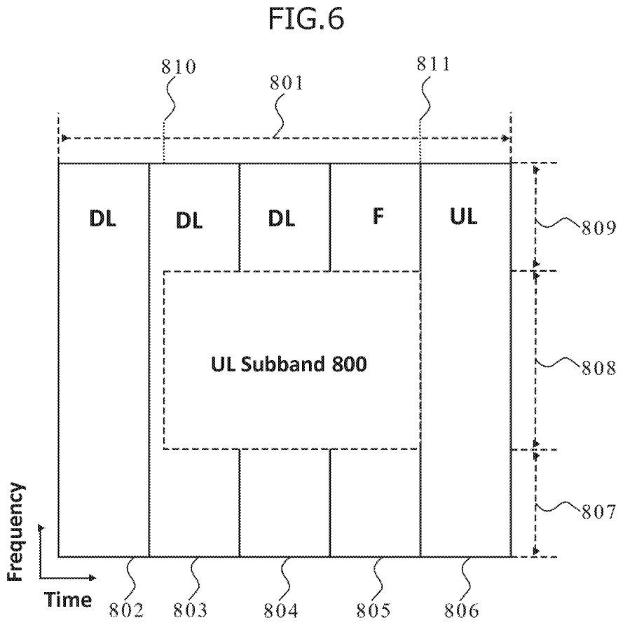

FIG. 6 is a diagram illustrating an example of a method of configuring the UL subband according to the present embodiment. A period 801 may be a period indicated by the higher layer parameter dl-UL-TransmissionPeriodicity. For example, the period 801 is P milliseconds. For example, the period 801 is P+P2 milliseconds. For example, the period 801 is P2 milliseconds. The period 801 may include a downlink slot 802, a downlink slot 803, a downlink slot 804, a flexible slot 805, and an uplink slot 806. The base station apparatus 100 may provide, to the terminal apparatus 200, a start timing 810 and an end timing 811 of an UL subband 800 in the time domain. The start timing 810 may be the first symbol included in the slot 803. The start timing 810 may be any symbol included in the downlink slot 803. The end timing 811 may be the last symbol included in the flexible slot 805. The end timing 811 may be any symbol included in the flexible slot 805. A symbol included in the downlink slot 803 that overlaps the UL subband 800, a symbol included in the downlink slot 804 that overlaps the UL subband 800, and a symbol included in the flexible slot 805 that overlaps the UL subband 800 may be SBFD symbols.

A bandwidth 808 is a bandwidth of the UL subband 800. The sum of a bandwidth 807, the bandwidth 808, and a bandwidth 809 may correspond to a bandwidth of the DL BWP. In the SBFD symbol, a bandwidth corresponding to the bandwidth 807 may correspond to a DL subband. In the SBFD symbol, a bandwidth corresponding to the bandwidth 809 may correspond to a DL subband. The DL subband may include a guardband.

A position of a frequency resource for an uplink channel and/or an uplink signal may be determined based on the UL BWP. For example, the position of a frequency resource for an uplink channel and/or an uplink signal is determined based on a starting PRB of the UL BWP. Alternatively, for example, the position of a frequency resource for an uplink channel and/or an uplink signal is determined based on a last PRB of the UL BWP. However, since a position of a frequency resource for an uplink channel and/or an uplink signal transmitted in the UL subband is determined based on the UL BWP, there is a possibility that the frequency resource for the uplink channel and/or the uplink signal is not located in the UL subband on the SBFD symbol. In a case where the frequency resource for the uplink channel and/or the uplink signal is not located in the UL subband on the SBFD symbol, the terminal apparatus 200 is not able to transmit the uplink channel and/or the uplink signal in the SBFD symbol in some cases.

In a case where the frequency resource for the uplink channel and/or the uplink signal is not located in the UL subband on the SBFD symbol, the base station apparatus 100 may provide an offset to the terminal apparatus 200 such that the frequency resource for the uplink channel and/or the uplink signal can be configured on the UL subband. In the first embodiment, the offset may be referred to as an SBFD offset. When the terminal apparatus 200 receives the SBFD offset, the terminal apparatus 200 may apply the SBFD offset to the resource corresponding to the uplink channel and/or the uplink signal based on a resource of the UL BWP. When the terminal apparatus 200 receives the SBFD offset, the terminal apparatus 200 may apply the SBFD offset to the resource corresponding to the uplink channel and/or the uplink signal based on a starting PRB index of the UL BWP. When the terminal apparatus 200 receives the SBFD offset, the terminal apparatus 200 may apply the SBFD offset to the resource corresponding to the uplink channel and/or the uplink signal based on a last PRB index of the UL BWP. When the terminal apparatus 200 receives the SBFD offset, the terminal apparatus 200 may apply the SBFD offset to the resource corresponding to the uplink channel and/or the uplink signal based on Point A. When the terminal apparatus 200 receives the SBFD offset, the terminal apparatus 200 may apply the SBFD offset to the resource corresponding to the uplink channel and/or the uplink signal based on another offset.

In a case where the terminal apparatus 200 does not have a dedicated PUCCH resource configuration provided by PUCCH-ResourceSet included in a higher layer parameter PUCCH-Config, a PUCCH resource set corresponding to an index indicated by a higher layer parameter pucch-ResourceCommon may be provided from a PUCCH resource set table. One PUCCH resource set may include 16 PUCCH resources. The PUCCH resource set may correspond to a PUCCH format, a first symbol, a duration, a PRB offset, and a cyclic shift index set for PUCCH transmission. The terminal apparatus 200 may transmit a PUCCH by using frequency hopping. In a case where the terminal apparatus 200 does not have the dedicated PUCCH resource configuration provided by PUCCH-ResourceSet included in the higher layer parameter PUCCH-Config, an orthogonal cover code (OCC) with an index 0 may be applied to the PUCCH format 1. In a case where the terminal apparatus 200 does not have the dedicated PUCCH resource configuration provided by PUCCH-ResourceSet included in the higher layer parameter PUCCH-Config, the terminal apparatus 200 may transmit a PUCCH by using the same spatial domain transmission filter as that for PUSCH transmission scheduled by the RAR UL grant.

FIG. 7 is a diagram illustrating an example of the PUCCH resource set table in a case where the terminal apparatus 200 does not have the dedicated PUCCH resource configuration in the present embodiment. An index included in the table may be an index of the PUCCH resource set. The index of the PUCCH resource set may be indicated by the higher layer parameter pucch-ResourceCommon. For example, in a case where the higher layer parameter pucch-ResourceCommon indicates the index 0 of the PUCCH resource set, a PUCCH resource included in the PUCCH resource set whose index is 0 may have a PUCCH format of 0, a starting symbol index of 12, a PUCCH symbol length of 2 symbols, a PRB offset of 0, and an initial cyclic shift set of 0 and 3.

In a case where a higher layer parameter pdsch-HARQ-ACK-Codebook is not provided to the terminal apparatus 200, the terminal apparatus 200 may generate HARQ-ACK information of up to 1 bit. In a case where the terminal apparatus 200 provides HARQ-ACK information for detection of DCI format 1_0, DCI format 1_1, or DCI format 1_2 via PUCCH transmission, the terminal apparatus 200 may determine the PUCCH resource by using an index rPUCCH. rPUCCH may be an integer which is a natural number within a range of 0 to 15. rPUCCH may be derived by using Formula 1. Here, NCCE may be the number of CCEs included in a CORESET in which a PDCCH including DCI format 1_0, DCI format 1_1, or DCI format 1_2 is received. nCCE,0 may be an index of the first CCE for the PDCCH reception. ΔPRI may be a PUCCH resource indicator included in DCI format 1_0, DCI format 1_1, or DCI format 1_2.

r_PUCCH=└(2·n_(CCE,0))/N_CCE┘+2Δ_PRI [Formula 1]

In a case where floor(rPUCCH/8) is 0, the terminal apparatus 200 may determine a PRB index of PUCCH transmission in a first hop by RBBWPoffset+floor(rPUCCH/NCS). In a case where floor(rPUCCH/8) is 0, a PRB index of PUCCH transmission in a second hop may be determined by NBWPsize−1−RBBWPoffset−floor(rPUCCH/NCS). Here, NCS may be the total number of initial cyclic shift indexes in an initial cyclic shift index set. In a case where floor(rPUCCH/8) is 0, the terminal apparatus 200 may determine an initial cyclic shift index in the initial cyclic shift index set by mod(rPUCCH, NCS). NBWPsize may be a size of the uplink BWP (UL BWP).

floor(x) may be the largest integer among integers equal to or less than a certain real number x. For example, floor(1.2) is 1. For example, floor(2.0) is 2. mod(A, B) is a modulo function, and may output a remainder when A is divided by B. For example, 3 mod 2 is 1. For example, 4 mod 2 is 0.

In a case where floor(rPUCCH/8) is 1, the terminal apparatus 200 may determine the PRB index of PUCCH transmission in the first hop by NBWPsize−1−RBBWPoffset−floor((rPUCCH−8)/NCS). In a case where floor(rPUCCH/8) is 1, the PRB index of PUCCH transmission in the second hop may be determined by RBBWPoffset+floor((rPUCCH−8)/NCS). In a case where floor(rPUCCH/8) is 1, the terminal apparatus 200 may determine an initial cyclic shift index in the initial cyclic shift index set by mod(rPUCCH−8, NCS).

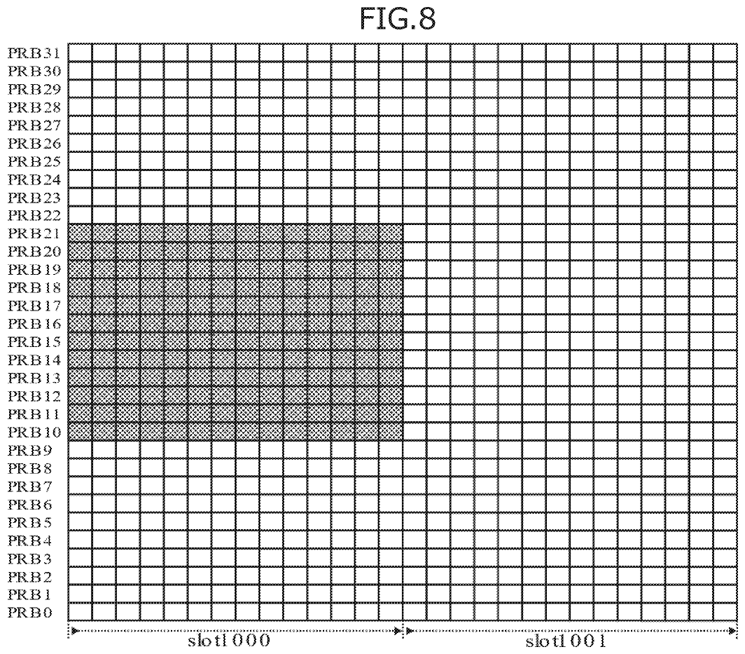

FIG. 8 illustrates an example of a resource grid in which the UL subband is configured in the present embodiment. A horizontal axis is a time axis, and a vertical axis is a frequency axis. It is assumed that the UL subband is configured from PRB10 to PRB21 in all symbols included in slot1000. It is assumed that the DL subband is configured from PRB0 to PRB9 and from PRB22 to PRB31 in all symbols included in slot1000. That is, all the symbols included in slot1000 may be SBFD symbols. In addition, it is assumed that slot1000 is determined as a downlink slot by the higher layer parameter tdd-UL-DL-ConfigurationCommon. It is assumed that slot1001 is determined as an uplink slot by the higher layer parameter tdd-UL-DL-ConfigurationCommon.

An example in which the terminal apparatus 200 transmits a PUCCH in slot1001 will be described. In addition, it is assumed that rPUCCH is 7. Further, it is assumed that a UL BWP size (NBWPsize) is 32 PRBs. The base station apparatus 100 indicates, to the terminal apparatus 200, the index 0 of the PUCCH resource set by using, for example, the higher layer parameter pucch-ResourceCommon. For example, the terminal apparatus 200 selects the PUCCH resource set whose index is 0 from the PUCCH resource set table illustrated in FIG. 7. For example, the terminal apparatus 200 determines a PUCCH resource from the PUCCH resource set by using rPUCCH. The PRB index of the first hop may be 3. The PRB index of the second hop may be 28. The initial cyclic shift index may be 1. As a result, the PUCCH resource determined by the terminal apparatus 200 may be configured such that {starting symbol of PUCCH resource: 12, length of PUCCH resource: 2, PRB index of first hop: 3, and PRB index of second hop: 28}. That is, in a case where frequency hopping is performed, the terminal apparatus 200 may transmit a PUCCH in PRB3 included in the thirteenth symbol and PRB28 included in the fourteenth symbol in slot 1001. In a case where frequency hopping is not performed, the terminal apparatus 200 may transmit a PUCCH in PRB3 included in the thirteenth symbol and the fourteenth symbol in slot1001.

An example in which the terminal apparatus 200 transmits a PUCCH in slot1000 will be described. In addition, it is assumed that rPUCCH is 7. Further, it is assumed that a UL BWP size (NBWPsize) is 32 PRBs. The base station apparatus 100 indicates, to the terminal apparatus 200, the index 0 of the PUCCH resource set by using, for example, the higher layer parameter pucch-ResourceCommon. For example, the terminal apparatus 200 selects the PUCCH resource set whose index is 0 from the PUCCH resource set table illustrated in FIG. 7. For example, the terminal apparatus 200 determines a PUCCH resource from the PUCCH resource set by using rPUCCH. The PRB index of the first hop may be 3. The PRB index of the second hop may be 28. The initial cyclic shift index may be 1. As a result, the PUCCH resource determined by the terminal apparatus 200 is configured such that, for example, {starting symbol of PUCCH resource: 12, length of PUCCH resource: 2, PRB index of first hop: 3, and PRB index of second hop: 28}. However, in slot1000, PRB3 and PRB28 are included in the DL subband, and thus, an offset may be applied such that the PUCCH resource is located in the UL subband. Here, an offset applied to the PRB index of the first hop is referred to as RBULsuboffset, first, and an offset applied to the PRB index of the second hop is referred to as RBULsuboffset, second. The offset RBULsuboffset, first applied to the first hop and the offset RBULsuboffset, second applied to the second hop may be different values or the same value. That is, in a case where floor(rPUCCH/8) is 0, the terminal apparatus 200 may determine the PRB index of PUCCH transmission in the first hop by RBBWPoffset+RBULsuboffset,first+floor(rPUCCH/NCS). Further, in a case where floor(rPUCCH/8) is 0, the terminal apparatus 200 may determine the PRB index of PUCCH transmission in the second hop by NBWPsize−1−RBBWPoffset-RBULsuboffset, second−floor(rPUCCH/NCS). In a case where floor(rPUCCH/ 8) is 1, the terminal apparatus 200 may determine the PRB index of the PUCCH transmission in the first hop by NBWPsize−1−RBBWPoffset-RBULsuboffset, first−floor((rPUCCH−8)/NCS). In a case where floor(rPUCCH/8) is 1, the PRB index of PUCCH transmission in the second hop may be determined by RBBWPoffset+RBULsuboffset, second+floor((rPUCCH−8)/NCS). NBWPsize may be the number of PRBs in the UL BWP. NBWPsize may be the number of PRBs in the DL BWP. Returning to the example of the PUCCH transmission in slot1000, for example, the terminal apparatus 200 may set any integer of 7 or more and 18 or less as RBULsuboffset, first, and determine a new PRB index by adding the integer to the predetermined PRB index of the first hop. Further, the terminal apparatus 200 may determine a new PRB index by subtracting RBULsuboffset, second from the predetermined PRB index of the second hop.

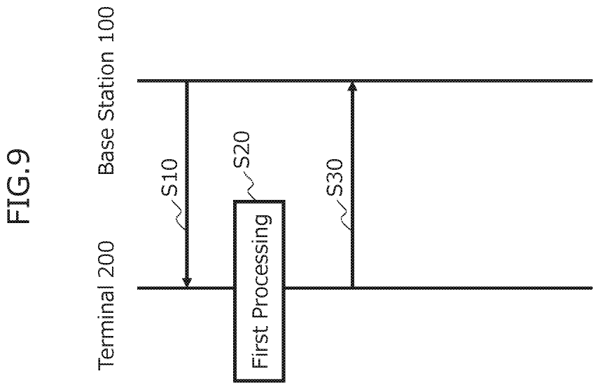

Here, a flow until the terminal for which the SBFD is configured transmits data in the first embodiment will be described. FIG. 9 is a sequence diagram of the wireless communication system 1 according to the present embodiment.

The transmitter 111 of the base station apparatus 100 transmits, to the terminal apparatus 200, a first signal including first information regarding a configuration of the SBFD and second information regarding a configuration of an uplink channel (step S10). Note that the first information regarding the configuration of the SBFD may be rephrased as the first information configuring the UL subband. In addition, the first information and the second information may be transmitted in different signals. Note that the first signal is, for example, a higher layer signal or an RRC layer signal. Furthermore, the second information regarding the configuration of the uplink channel may be, for example, information regarding a configuration of an uplink control channel or information regarding a configuration of a random access channel.

The controller 220 of the terminal apparatus 200 performs first processing of configuring the SBFD according to the information regarding the configuration of the SBFD (step S20). Note that, when configuring the SBFD, the controller 220 of the terminal apparatus 200 adjusts an uplink resource so as to be located in the uplink subband by using, for example, an offset value. Note that details of the offset value are described below.

The transmitter 211 of the terminal apparatus 200 transmits an uplink signal in the uplink subband configured by the first processing (step S30).

Note that, in FIG. 9, a signal indicating completion may be transmitted after completion of the configuration of the SBFD. Furthermore, in a case where data is included in the uplink signal transmitted in step S30, the receiver 212 of the terminal apparatus 200 may receive a reception acknowledgement response for the uplink signal. Further, before the transmission in step S30, a downlink signal may be received, and a response signal (for example, a PUCCH including information regarding HARQ) for the downlink signal may be transmitted as a third signal.

Here, the offset value will be described.

A first example for the offset value will be described. The first example is an example in which the base station apparatus 100 notifies the terminal apparatus 200 of the offset value. The base station apparatus 100 may provide first offsets, RBULsuboffset, first and RBULsuboffset, second, to the terminal apparatus 200 for the PRB index of the first hop and/or the PRB index of the second hop determined by the terminal apparatus 200. The first offset may be provided via a higher layer parameter. In short, third information regarding the first offset is included in the first signal and transmitted. The first offset is, for example, a value for adjustment in which the PRB index of the first hop and/or the PRB index of the second hop is included in the UL subband. The third information may be included in the first information.

Next, a second example for the offset value will be described. The second example is an example in which the terminal apparatus 200 determines the offset value in the configuration of the SBFD. The terminal apparatus 200 may determine second offsets, RBULsuboffset, first and RBULsuboffset, second. The second offset is, for example, a value for adjustment in which the PRB index of the first hop and/or the PRB index of the second hop is included in the UL subband. For example, the terminal apparatus 200 may determine the second offset by using the starting PRB index of the UL subband and the starting PRB index of the UL BWP. For example, the terminal apparatus 200 may determine the second offset RBULsuboffset, first to be applied to the first hop based on a difference between the starting PRB index of the UL subband and the starting PRB index of the UL BWP. For example, the terminal apparatus 200 may determine the second offset RBULsuboffset, first to be applied to the first hop based on a difference between the starting PRB index of the UL subband and a starting PRB index of the DL BWP. For example, the terminal apparatus 200 may determine the second offset RBULsuboffset, second to be applied to the second hop based on a difference between the last PRB index of the UL subband and the last PRB index of the UL BWP. For example, the terminal apparatus 200 may determine the second offset RBULsuboffset, second to be applied to the second hop based on a difference between the last PRB index of the UL subband and a last PRB index of the DL BWP.

Next, a third example for the offset value will be described. The third example is an example of determining a PRB index of the PUCCH resource in slot1000. In a case where floor(rPUCCH/8) is 0, the terminal apparatus 200 may determine the PRB index of PUCCH transmission in the first hop by RBBWPoffset+nULsubStart+floor(rPUCCH/NCS). Here, nULsubStart may be the starting PRB index of the UL subband. In a case where floor(rPUCCH/8) is 0, the PRB index of PUCCH transmission in the second hop may be determined by NULsubsize+nULsubStart−1−RBBWPoffset−floor(rPUCCH/NCS). Here, NULsubsize may be the number of PRBs in the bandwidth of the UL subband. In a case where floor(rPUCCH/8) is 0, the terminal apparatus 200 may determine an initial cyclic shift index in the initial cyclic shift index set by mod(rPUCCH, NCS). In a case where floor(rPUCCH/8) is 1, the terminal apparatus 200 may determine the PRB index of PUCCH transmission in the first hop by NULsubsize+nULsubStart−1−RBBWPoffset−floor((rPUCCH−8)/NCS). In a case where floor(rPUCCH/8) is 1, the PRB index of PUCCH transmission in the second hop may be determined by RBBWPoffset+nULsubStart+floor((rPUCCH−8)/NCS). In a case where floor(rPUCCH/8) is 1, the terminal apparatus 200 may determine an initial cyclic shift index in the initial cyclic shift index set by mod(rPUCCH−8, NCS).

Next, a method for adjustment to the UL subband without using the offset value will be described. For example, the base station apparatus 100 configures a size of the UL BWP configured for the terminal apparatus 200 so as to be equal to or smaller than a size of the UL subband. Note that information regarding the size of the UL subband and the size of the UL BWP is transmitted in the first signal, for example. The base station apparatus 100 may configure the size of the UL subband so as to be equal to the size of the UL BWP. In a case where the size of the UL subband is equal to or larger than the size of the UL BWP, the starting PRB index of the first hop and/or the second hop may be determined based on the size of the UL BWP. In a case where the size of the UL subband is smaller than the size of the UL BWP, the starting PRB index of the first hop and/or the second hop may be determined based on the size of the UL subband.

Next, a control example of the terminal apparatus 200 in a case where the terminal apparatus 200 does not have a dedicated PUCCH resource configuration will be described. In a case where the terminal apparatus 200 does not have a dedicated PUCCH resource configuration, the terminal apparatus 200 performs control so as not to transmit a PUCCH in a symbol where the SBFD symbol is configured. In addition, in a case where the terminal apparatus 200 does not have a dedicated PUCCH resource configuration, the terminal apparatus 200 performs control to transmit a PUCCH in a symbol where no SBFD symbol is configured. For example, the terminal apparatus 200 is not expected to transmit a PUCCH in slot1000. For example, the terminal apparatus 200 is expected to transmit a PUCCH in slot1001. In this way, for example, in the UL subband, only an allocated uplink signal is transmitted by using, for example, downlink control information. Therefore, a resource for transmitting a PUCCH is not located in the DL subband. The downlink control information may indicate that a PUCCH is to be transmitted in an uplink-only slot. Note that this example can be used in combination with the example using the offset and the example not using the offset described above.

Next, a method of controlling a position of a random access channel (RACH) occasion (RO) will be described. Note that, in this example, the first signal transmitted in step S10 in FIG. 9 is, for example, a higher layer signal such as SIB1 and includes various higher layer parameters. In addition, in the first processing performed in step S20 in FIG. 9, processing of adjusting the RO so as to be located in the UL subband is performed. The second signal transmitted in step S30 in FIG. 9 is, for example, a random access signal (for example, MSGA or MSG1). In a case where the RO is configured on an UL symbol that is not the SBFD symbol, a frequency-domain position of the RO may be determined by a higher layer parameter msg1-FrequencyStart. The higher layer parameter msg1-FrequencyStart may be an offset from the starting PRB index of the UL BWP. In a case where the RO is configured on the UL subband included in the SBFD symbol, the frequency-domain position of the RO may be determined by the higher layer parameter msg1-FrequencyStart and a higher layer parameter msg1-SBFDFrequencyStart. The higher layer parameter msg1-SBFDFrequencyStart may be an offset from the starting PRB index of the UL BWP. The higher layer parameter msg1-SBFDFrequencyStart may be an offset from a PRB index determined by the higher layer parameter msg1-FrequencyStart.

Next, in a flexible symbol and/or a flexible slot, in a case where the terminal apparatus 200 has configuration information of uplink transmission in the SBFD symbol and configuration information of an uplink signal in a symbol (non-SBFD symbol) that is not the SBFD symbol, the terminal apparatus 200 may apply only the configuration information of the uplink transmission in the SBFD symbol. The configuration information of the uplink transmission may be information carried by a higher layer parameter and/or DCI for transmission of an uplink channel and/or an uplink signal.

In a flexible symbol and/or a flexible slot, in a case where the terminal apparatus 200 has configuration information of uplink transmission in the SBFD symbol and configuration information of an uplink signal in a symbol (non-SBFD symbol) that is not the SBFD symbol, the terminal apparatus 200 may apply only the configuration information of the uplink transmission in a symbol that is not the SBFD symbol.

In a flexible symbol and/or a flexible slot, in a case where the terminal apparatus 200 has configuration information of uplink transmission in the SBFD symbol and configuration information of an uplink signal in a symbol (non-SBFD Symbol) that is not the SBFD symbol, the terminal apparatus 200 may apply the configuration information of the uplink transmission in the SBFD symbol and the configuration information of the uplink transmission in a symbol that is not the SBFD symbol.

Next, in a flexible symbol and/or a flexible slot, in a case where the terminal apparatus 200 has configuration information of downlink transmission in the SBFD symbol and configuration information of a downlink signal in a symbol (non-SBFD symbol) that is not the SBFD symbol, the terminal apparatus 200 may apply only the configuration information of the downlink transmission in the SBFD symbol. The configuration information of the downlink transmission may be information carried by a higher layer parameter and/or DCI for transmission of a downlink channel and/or a downlink signal.

In a flexible symbol and/or a flexible slot, in a case where the terminal apparatus 200 has configuration information of downlink transmission in the SBFD symbol and configuration information of a downlink signal in a symbol (non-SBFD symbol) that is not the SBFD symbol, the terminal apparatus 200 may apply only the configuration information of the downlink transmission in a symbol that is not the SBFD symbol.

In a flexible symbol and/or a flexible slot, in a case where the terminal apparatus 200 has configuration information of downlink transmission in the SBFD symbol and configuration information of a downlink signal in a symbol (non-SBFD Symbol) that is not the SBFD symbol, the terminal apparatus 200 may apply the configuration information of the downlink transmission in the SBFD symbol and the configuration information of the downlink transmission in a symbol that is not the SBFD symbol.

In PUSCH transmission scheduled by the RAR UL grant or Msg3 PUSCH retransmission, to which frequency hopping is applied, a third offset may be applied to a starting PRB index of a frequency resource of the second hop. In a case where the UL BWP size (NUL, BWPsize) is less than 50, the first offset may have a value of floor(NUL, BWPsize/2) or floor(NUL, BWPsize/4). In a case where the UL BWP size (NUL, BWPsize) is 50 or more, the third offset may have a value of floor(NUL, BWPsize/2), floor(NUL, BWPsize/4), or −floor(NUL, BWPsize/4).

In PUSCH transmission scheduled by RAR UL grant or Msg3 PUSCH retransmission, to which frequency hopping is applied, in a case where the terminal apparatus 200 transmits the corresponding Msg3 PUSCH in the UL subband, the third offset and a fourth offset may be applied as the starting PRB indexes of the frequency resource of the second hop. In a case where the UL BWP size (NUL, BWPsize) is less than 50, the third offset may have a value of floor(NUL, BWPsize/2) or floor(NUL, BWPsize/4). In a case where the UL BWP size (NUL, BWPsize) is 50 or more, the third offset may have a value of floor(NUL, BWPsize/2), floor(NUL, BWPsize/4), or −floor(NUL, BWPsize/4). The fourth offset may be given to the terminal apparatus 200 by a higher layer parameter. The fourth offset may be given to the terminal apparatus 200 by DCI. An offset that corresponds to the sum of the third offset and the fourth offset may be applied as the starting PRB index of the second hop. The fourth offset may be an offset from the third offset, or may be an offset from the starting PRB index of the UL BWP, or may be an offset from Point A. The fourth offset may be applied as the starting PRB index of the first hop.

In a flexible symbol and/or a flexible slot, in a case where the third offset and the fourth offset are given to the terminal apparatus 200, the terminal apparatus 200 may apply only the third offset to the Msg3 PUSCH. In a flexible symbol and/or a flexible slot, in a case where the third offset and the fourth offset are given to the terminal apparatus 200, the terminal apparatus 200 may apply only the fourth offset to the Msg3 PUSCH. In a flexible symbol and/or a flexible slot, in a case where the third offset and the fourth offset are given to the terminal apparatus 200, the terminal apparatus 200 may apply either offset or both offsets to the Msg3 PUSCH.

As described above, in the first embodiment, control can be performed such that a resource of an uplink channel is located in the UL subband by using the first information and the second information transmitted from the base station apparatus 100 to the terminal apparatus 200. Therefore, for example, in the SBFD, the resource of the uplink channel is not located in the DL subband.

### Hardware Configuration of Each Apparatus in Each Embodiment

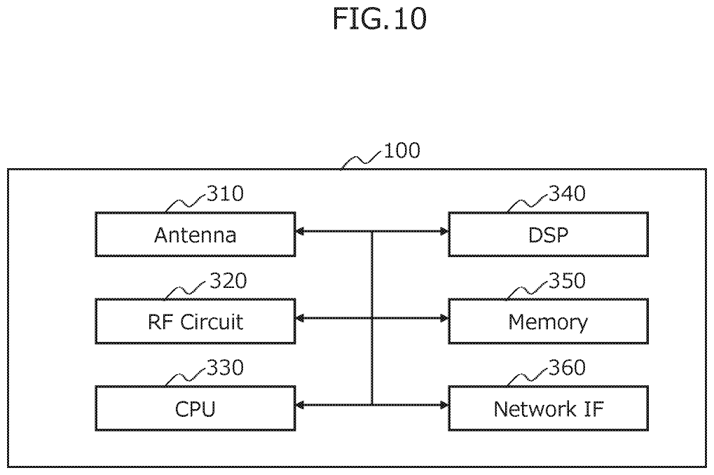

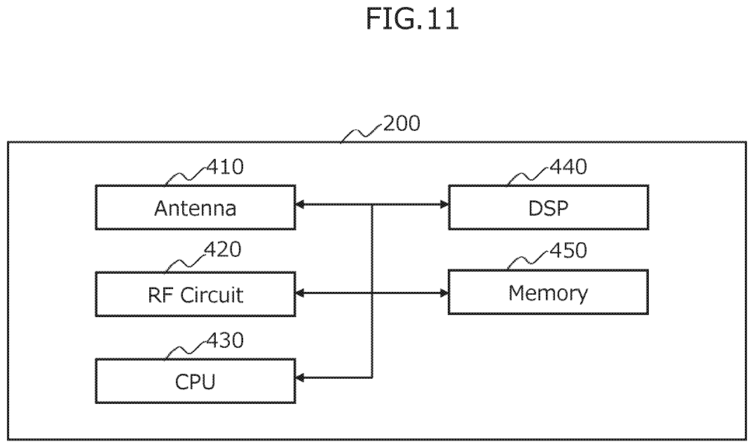

A hardware configuration of each apparatus in the wireless communication system of each embodiment will be described based on FIGS. 10 and 11.

FIG. 10 is a diagram illustrating an example of a hardware configuration of the base station apparatus 100 according to the present embodiment. As illustrated in FIG. 10, the base station apparatus 100 includes, for example, a radio frequency (RF) circuit 320 including an antenna 310, a central processing unit (CPU) 330, a digital signal processor (DSP) 340, a memory 350, and a network interface (IF) 360 as hardware components. The CPU is connected via a bus so as to be able to input and output various signals and data signals. The memory 350 includes, for example, at least one of a random access memory (RAM) such as a synchronous dynamic random access memory (SDRAM), a read only memory (ROM), and a flash memory, and stores a program, control information, and a data signal.

A correspondence between the functional configuration of the base station apparatus 100 illustrated in FIG. 2 and the hardware configuration of the base station apparatus 100 illustrated in FIG. 10 will be described. The transmitter 111 and the receiver 112 (or the communicator 140) are implemented by, for example, the RF circuit 320, or the antenna 310 and the RF circuit 320. The controller 120 is implemented by, for example, the CPU 330, the DSP 340, the memory 350, and a digital electronic circuit (not illustrated). Examples of the digital electronic circuit include an application specific integrated circuit (ASIC), a field-programming gate array (FPGA), and a large scale integration (LSI).

Note that, in the base station apparatus 100, a plurality of data signals transmitted in a plurality of subbands can be generated, but a filter for generating the data signals may be configured independently for each subband.

FIG. 11 is a diagram illustrating an example of a hardware configuration of the terminal apparatus 200 according to the present embodiment. As illustrated in FIG. 11, the terminal apparatus 200 includes, for example, an RF circuit 420 including an antenna 410, a CPU 430, a DSP 440, and a memory 450 as hardware components. Furthermore, the terminal apparatus 200 may include a display apparatus such as a liquid crystal display (LCD) connected to the CPU 430. The memory 450 includes, for example, at least one of a RAM such as an SDRAM, a ROM, and a flash memory, and stores a program, control information, and a data signal.

A correspondence between the functional configuration of the terminal apparatus 200 illustrated in FIG. 3 and the hardware configuration of the terminal apparatus 200 illustrated in FIG. 11 will be described. The transmitter 211 and the receiver 212 (or the communicator 210) are implemented by, for example, the RF circuit 420, or the antenna 410 and the RF circuit 420. The controller 220 is implemented by, for example, the CPU 430, the DSP 440, the memory 450, and a digital electronic circuit (not illustrated). Examples of the digital electronic circuit include an ASIC, an FPGA, and an LSI.

Note that, in each embodiment, examples of the base station apparatus, the terminal apparatus, and a relay have been described, but the disclosed technology is not limited thereto, and can be applied to various apparatuses such as electronic devices mounted on automobiles, trains, airplanes, artificial satellites, and the like, electronic devices carried by drones and the like, robots, AV devices, household appliances, office devices, vending machines, and other household appliances.

In each embodiment, the fifth generation mobile communication has been described as an example. However, the disclosed technology is not limited thereto. For example, the disclosed technology may be applied to mobile communication of different generations such as the sixth generation and the seventh generation.

It is possible to provide a terminal, a base station apparatus, a wireless communication system, and the like, which can increase a probability of success of a random access procedure when an RO configured on an UL subband and an RO configured on a resource other than the UL subband are configured.

Throughout the descriptions, the indefinite article “a” or “an”, or adjective “one” does not exclude a plurality.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A terminal apparatus comprising:
a receiver configured to receive first information regarding a configuration of an uplink (UL) subband and second information regarding a resource of an uplink channel;
a controller configured to perform control such that the resource of the uplink channel is located in the UL subband according to the first information and the second information; and
a transmitter configured to transmit the uplink channel on the resource.

2. The terminal apparatus according to claim 1, wherein the uplink channel is an uplink control channel, and the first information includes offset information for adjusting a position of the resource.

3. The terminal apparatus according to claim 1, wherein the controller adjusts a position of the resource by using a starting physical resource block (PRB) index of the UL subband and a starting PRB index of a UL bandwidth part (BWP).

4. The terminal apparatus according to claim 1, wherein the second information is an information regarding a physical uplink control channel (PUCCH), and a position of the resource is a position of a PUCCH resource.

5. The terminal apparatus according to claim 1, wherein the controller performs adjustment such that the resource is located in a predetermined frequency configuring the UL subband.

6. A base station apparatus comprising:
a transmitter configured to transmit first information regarding a configuration of an uplink (UL) subband and second information regarding a resource of an uplink channel; and
a receiver configured to receive the uplink channel on the resource that is controlled such that the resource of the uplink channel is located in the UL subband according to the first information and the second information.

7. A wireless communication system comprising:
a base station apparatus configured to transmit first information regarding a configuration of an uplink (UL) subband and second information regarding a resource of an uplink channel; and
a terminal apparatus configured to receive the first information and the second information, perform control such that the resource of the uplink channel is located in the UL subband according to the first information and the second information, and transmit the uplink channel on the resource.
